(19) United States
(12) Patent Application Publication
(10) Pub. No.: US 2012/0020656 A1
(43) Pub. Date: Jan. 26, 2012

(54) PORTABLE CAMERA SUPPORT APPARATUS

(76) Inventor: Richard Farmer, Huntington Beach, CA (US)

(21) Appl. No.: 12/842,392

(22) Filed: Jul. 23, 2010

(51) Int. Cl. G03B 17/00

(52) U.S. Cl. 396/420

(57) ABSTRACT

The present invention is a portable camera support apparatus designed to enable a user to record videos or capture still images while simultaneously performing action sports, aquatic activities, or various other extreme activities. More particularly, such portable camera support apparatus comprises a tubular member to hold a portable camera, grips on the tubular member for the user to comfortably hold and control the portable camera support apparatus with one or both hands at either end, a pivot coupler for attaching the portable camera to the tubular member, and an optional opening to enhance movement under water for aquatic activities. A portable camera support apparatus may also comprise a control switch, a pivot control, and a pivoting axis enabling a user to serve as the director of the videos or images captured by turning the camera on or off, adjusting the angle the camera is facing, taking snap shot images or controlling various other features of the camera. A portable camera support apparatus may also comprise a camera housing unit to protect the camera during performance of action sports. A portable camera support apparatus may also comprise detachable connection rings to assist in the recovery of the portable camera support apparatus during performance of actions sports.

### TECHNICAL FIELD OF THE INVENTION

The present invention relates in general to a portable camera support apparatus, and more specifically, to a support structure with control capabilities to be used in action sports, aquatic and other extreme activities.

### COPYRIGHT & TRADEMARK NOTICE

A portion of the disclosure of this patent application may contain material that is subject to copyright protection. The owner has no objection to the facsimile reproduction of any one of the patent documents or the patent disclosure as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### BACKGROUND OF THE INVENTION

In the wake of the recent technological breakthrough in electronic storage and online social network sharing, the demand and interest in recording and sharing exciting and memorable activities has increased as well. As such, participants in action sports, aquatic, or other extreme activities embrace recording videos or capturing still images of themselves, other individuals, and also the surrounding environment while performing the activity. Various difficulties associated with having a second individual following the sports action participant can be avoided by enabling a user to capture such videos or still images while performing the activity. Moreover, given such ability, the user can serve as the director of the recorded images or videos by deciding which view or moments of the activity are best to be recorded.

Safety concerns and practicality demand that such a recording device to be well suited for the environment of the activity and also to be easily manageable by the user during performance of the action sport or extreme activity. For instance, aquatic activities, such as scuba diving, snorkeling, and swimming require such a device to be resistant to water and the forces experienced under water. Some sports and activities may require such a device to be operable by one hand while using the other hand to perform the activity. Other sports and activities, however, may require two hands for operation during performance of the extreme sport or activity. Further, there is a need for such devices to allow for the user to easily pivot or turn the camera, either manually, mechanically or by other means, in order to adjust the direction or angle in which the camera faces during performance of the action sport or extreme activity.

Additionally, existing devices make it difficult to capture a continuous stream of usable video during the performance of action sport or extreme activity. Devices such as helmet cameras or jacket cameras are attached to the user, thereby are limited to pointing in one direction or in the direction the user is looking. As such, there is a need for a device with the ability to allow a user to film in a desired direction, or to change the direction the camera is facing, irrespective of the direction that the user is looking or facing.

Thus, there is a need in the art for portable camera support apparatus for use while performing an action sport or extreme activity that allows a user to capture still images or video of the user, other individuals, or the surrounding environment without the assistance of others. It is to these ends that the present invention has been developed.

### SUMMARY OF THE INVENTION

To minimize the limitations in the prior art and other limitations that will be apparent upon reading and understanding the present specification, the present invention describes an exemplary use of a portable camera support apparatus that enables a user to capture still images or videos comfortably during performance of action sports, thereby obviating difficulties associated with having another individual record the user or difficulties with controlling a portable camera's functions directly during performance of sports action or other extreme activities.

The present invention further describes a portable camera support apparatus used during performance of action sports, comprising a portable camera for capturing audio and visual data, a tubular member for supporting the portable camera, a pivot coupler for attaching the portable camera to the tubular member, an optional opening to enhance movement under water for aquatic activities, a first grip firmly secured at a distal end of the tubular member, and a second grip firmly secured at a proximal end of the tubular member, thereby allowing a user to hold the apparatus to record video or still images while performing action sports or other extreme activities.

The present invention further describes a variation of a support apparatus for a portable camera comprising a portable camera for recording still images or videos, a tubular member for supporting the portable camera connected to grip on a distal end and to the portable camera at a proximal end, single grip for one-handed use firmly secured at a distal end of the tubular member, a pivot coupler for attaching the portable camera to the tubular member, an optional opening to enhance movement under water for aquatic activities, thereby enabling the user to hold the support apparatus with one hand while reserving the other hand for performing action sports.

The present invention further describes a variation of the support apparatus comprising a portable camera for capturing audio and visual data, a tubular member for supporting the portable camera, a pivot coupler for attaching the portable camera to the tubular member, an optional opening to enhance movement under water for aquatic activities, a pivot activation mechanism for rotating the portable camera upon the pivot couple, a portable camera activation mechanism for activating the portable camera, thereby enabling the user to activate the portable camera to take a visual snapshot, activate the portable camera to begin filming, deactivate the portable camera to stop filming, the portable camera on or off, or activate some other portable camera function.

It is an objective of the present invention to provide a durable apparatus that controls a portable camera's functions while the user performs sports, outdoor or aquatic activities, thereby enabling convenient recording of still images or videos.

It is another objective of the present invention to provide a user control of features of a camera without having to control the camera directly, thereby enhancing the user's performance of the activity and the user' s safety.

It is another objective of the present invention to control functions of the camera to allow the user to record images or videos of the user, other individuals, or the environment.

Finally, it is yet another objective of the present invention to allow the user to control the power of the camera, pivot the angle the camera is facing, taking snapshot images, and other functions of the portable camera conveniently in order for the user to serve as the sole director of the action sports experience.

These and other advantages and features of the present invention are described herein with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates exemplary usage of a portable camera support apparatus in accordance with the present invention.

FIG. 2 is a simplified illustration of a perspective view of a portable camera support apparatus in accordance with the present invention.

FIG. 3 is a simplified illustration of a perspective view of a portable camera support apparatus in accordance with the present invention.

FIG. 4(a) is a simplified illustration of a perspective view of a portable camera support apparatus in accordance with the present invention.

FIG. 4(b) is a simplified illustration of a perspective view of a portable camera support apparatus in accordance with the present invention.

FIG. 5 is a simplified illustration of a perspective view of a portable camera support apparatus in accordance with the present invention.

### DETAILED DESCRIPTION OF THE DRAWINGS

In the following discussion that addresses a number of embodiments and applications of the present invention, reference is made to the accompanying drawings that form a part hereof; these depictions are made by way of illustration and of specific embodiments in which the invention may be practiced. It is to be understood that other embodiments may be utilized and changes may be made without departing from the scope of the present invention.

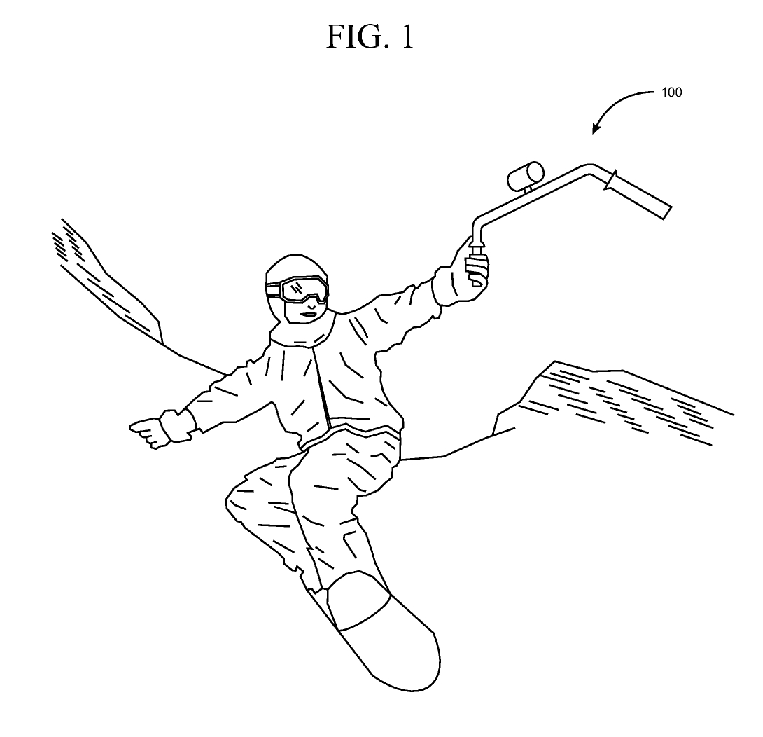

FIG. 1 illustrates exemplary usage of a portable camera support apparatus in accordance with the present invention. FIG. 1 shows portable camera support apparatus 100, which is designed to enable a user to capture video or still images while performing action sports or other extreme activities. The components of portable camera support apparatus 100 are discussed in the following paragraphs.

In the exemplary usage of portable camera support apparatus 100, as illustrated in FIG. 1, a user may hold portable camera support apparatus 100 with one or both hands and capture still images or videos during performance of an action sport or extreme activity, such as snowboarding. In various embodiments of the present invention, a user may control camera functions to turn the camera on or off, and take snap-shot images of the user, other individuals, or the surrounding environment. Further, the user has the option to control portable camera support apparatus 100 and camera functions with one hand while the user' s other hand may be free for performance of the activity.

Utilization of portable camera support apparatus 100 enhances the user's safety and performance while capturing video or images during an action sports because portable camera support apparatus 100 obviates the need to control camera features directly. When using portable camera support apparatus 100, the user can comfortably control various camera functions to choose the angle and the best time to capture videos or images during the action sport or extreme activity.

Camera support apparatus 100 may be used with various action sports or extreme activities other than snowboarding, as shown in FIG. 1. Action sports or other activities include, but are not limited to, various land sports such as skateboarding, skating, skiing, snowboarding, ice skating, tubing, rollerblading, running, hiking, skydiving, and various aquatic activities such as scuba diving, surfing, body boarding, swimming, waterskiing, white water rafting, or other extreme sports and activities.

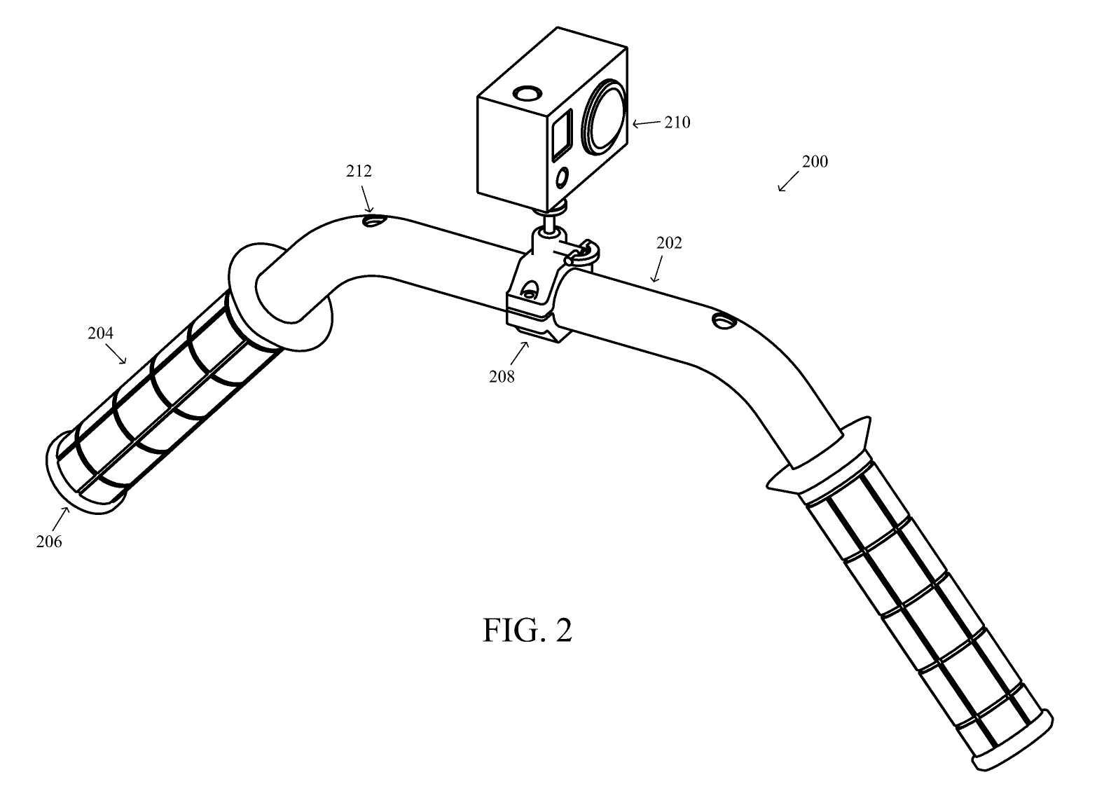

FIG. 2 is a simplified illustration of a perspective view of a portable camera support apparatus in accordance with the present invention. FIG. 2 shows portable camera support apparatus 200, comprising tubular member 202, grip 204, bar plug 206, pivot coupler 208, portable camera 210, and opening 212. Portable camera support apparatus 200 is designed to enable a user to capture video or still images while participating in an action sport or extreme activity.

Tubular member 202 is an object designed to serve as a high strength tube forming the backbone structure of portable camera support apparatus 200. In an exemplary embodiment, tubular member 202 may have a straight form in its center and curl towards its distal and proximal ends to facilitate a user's grip and support of the device with their hands. In such embodiments, tubular member 202 may be made of high strength aluminum tubing to be water resistant, light-weight, durable, and strong in face of possible collision with other objects or forces. Alternatively, tubular member 202 may be composed of water resistant metal, alloy, plastic, elastic materials, a combination of such materials, or various other materials.

In an exemplary embodiment of portable camera support apparatus 200, tubular member 202 may be rigid and inflexible to collision, air resistance, or other forces during performance of action sports or extreme activities. Further, tubular member 202 joint sections may be bent, shaped, or angled to allow various configurations to enable more comfortable grip or better positioning of the camera, as the user sees fit.

Grip 204 enables the user to hold portable camera support apparatus 200 with one of their hands while performing an activity. In an exemplary embodiment, grip 204 may comprise a first grip at a distal end of tubular member 202 to be held with one hand of the user. In such an embodiment, portable camera support apparatus 200, as illustrated in FIG. 2, may comprise a second grip 204 at a proximal end of tubular member 202, such that, in exemplary usage, a user may switch hands holding portable camera support apparatus 200 to change the direction of portable camera 210. Alternatively, in some embodiments, a user can hold portable camera support apparatus 200 with both hands upon grips 204 during performance of an action sport or extreme activity, such as scuba diving, or passing of portable camera support apparatus 200 between participants of the activity.

In such embodiments of the present invention, grip 204 may comprise a BMX® grip, used extensively in cycling. This embodiment would allow high wrist control of portable camera support apparatus 200, thereby enabling the user to perform the activity while simultaneously operating portable camera support apparatus 200. Alternatively, grip 204 may comprise an ergonomic grip that reduces grip force necessary to manipulate portable camera support apparatus 200 while maintaining comfortable handling. Grip 204 may comprise alternative structures or be composed of materials including but not limited to metal, plastic, alloy, combination of the preceding materials, and various other materials. Such materials may be entirely water resistant, covered with water resistant materials, or materials that would seal the materials inside from passage of water depending on whether the portable camera support apparatus is to be used for aquatic activities as well.

Bar plug 206 is an exemplary component of portable camera support apparatus 200 that, when attached to grip 204, promotes safety of the user. Bar plug 206 serves to maintain the placement of grip 204 upon portable camera support apparatus 200 when the user holds grip 204 in opposition to various forces, such as wind, water, or physical impact, during performance of an action sport or extreme activity. Bar plug 206 may be composed of plastic, metal, alloy, combination of the preceding materials or various other materials. Such materials may have similar characteristics as grip 204 to remain intact in face of the aforementioned forces.

Pivot coupler 208 is an object designed to attach portable camera 210 to tubular member 202. In the exemplary model of pivot coupler 208 illustrated in FIG. 2, pivot coupler 208 may be tightened or loosened via mechanical means prior to the performance of an action sport or extreme activity. For example, should pivot coupler 208 comprise a screw tightening mechanism, should pivot coupler 208 be tightened, portable camera 210 cannot be rotated without the loosening of pivot coupler 208. Pivot coupler 208 can be manufactured in various configurations to enhance firm attachment to portable camera 210 while remaining attached to tubular member 202. In an exemplary embodiment, pivot coupler 208 may comprise a set screw as illustrated to allow for fixing the camera to a preferred position on portable camera support apparatus 200 and adjust the preferred angle the camera faces to enable capturing images or videos of the users, other individuals, or the surrounding environment. Other alternative methods of attaching portable camera 210 to tubular member 202 are possible through attachment clamp or various other attaching mechanisms.

Portable camera 210 is a component of portable camera support apparatus 200 that may be utilized to capture audio, video or still images. In an exemplary embodiment, portable camera 210 may comprise a camera housing that is attachable and detachable to pivot coupler 208. In alternative embodiments, portable camera 210 may comprise a housing that is water resistant, impact collision resistant, or a housing that promotes durability during the performance of an action sport or extreme activity. In an alternative configuration, a camera that is resistant in face of water pressure and resistance, collision, and other forces can be mounted directly on portable camera support apparatus 200 without the housing unit. Various types of cameras in analog or digital form, with capability of producing color, black and white, or other video or still image outputs, with various other characteristics can be mounted on portable camera support apparatus 200 via pivot coupler 208.

Vent 212 is a component of portable camera support apparatus 200 that, when submerged underwater, allows trapped air to escape the interior of tubular member 202, thereby enabling portable camera support apparatus 200 to be neutrally buoyant while submersed in water, facilitating movement and control of portable camera support apparatus 200. In an exemplary embodiment, vent 212 may be present to enhance the aforementioned effects for aquatic or any other extreme activities. Alternatively, vent 212 may not be present depending on the type of activities that portable camera support apparatus 200 is designed for.

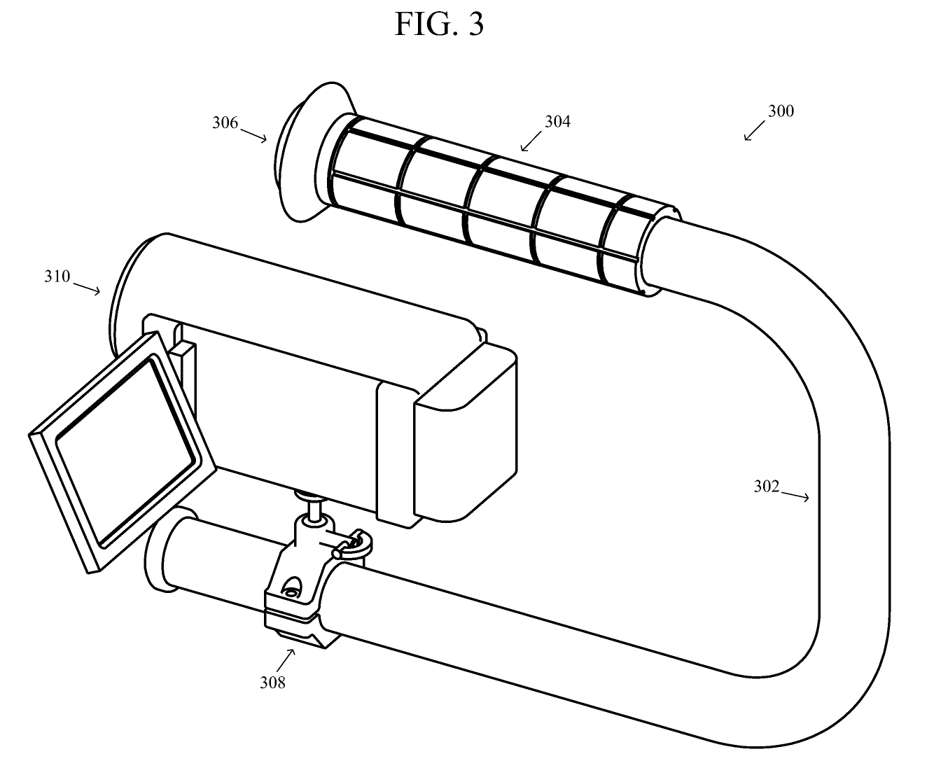

FIG. 3 is a simplified illustration of a perspective view of a portable camera support apparatus in accordance with the present invention. FIG. 3 shows portable camera support apparatus 300, comprising tubular member 302, grip 304, bar plug 306, pivot coupler 308, and portable camera 310. portable camera support apparatus 300 is designed to capture still or video images generated by portable camera 310 using only one hand, thereby enabling a user to use the other hand to perform sports or activities including but not limited to skateboarding, skiing, snowboarding, body boarding, rollerblading, and various other action sports or extreme activities. This variation would enable the user to perform more activities that would require use of at least one hand. Moreover, this variation ensures that safety of the user is taken into consideration by reserving a hand for performing such sports or activities.

Tubular member 302 is roughly U-shaped such that at one end, grip 304 can be held by a user while performing action sports using one or two hands. At the other end of tubular member 302, portable camera 310 is located such that the user can perform action recording images or videos with one hand, thereby enhancing the user's control of the angle portable camera 310 is facing and the user's control of other features of portable camera 310 during performance of an action sport or extreme activity. Alternatively, tubular member 302 can be shaped, angled, or curled in other configurations. The shape of tubular member 302 or manner of its connection to other components should not be considered to be limiting the scope of the present invention.

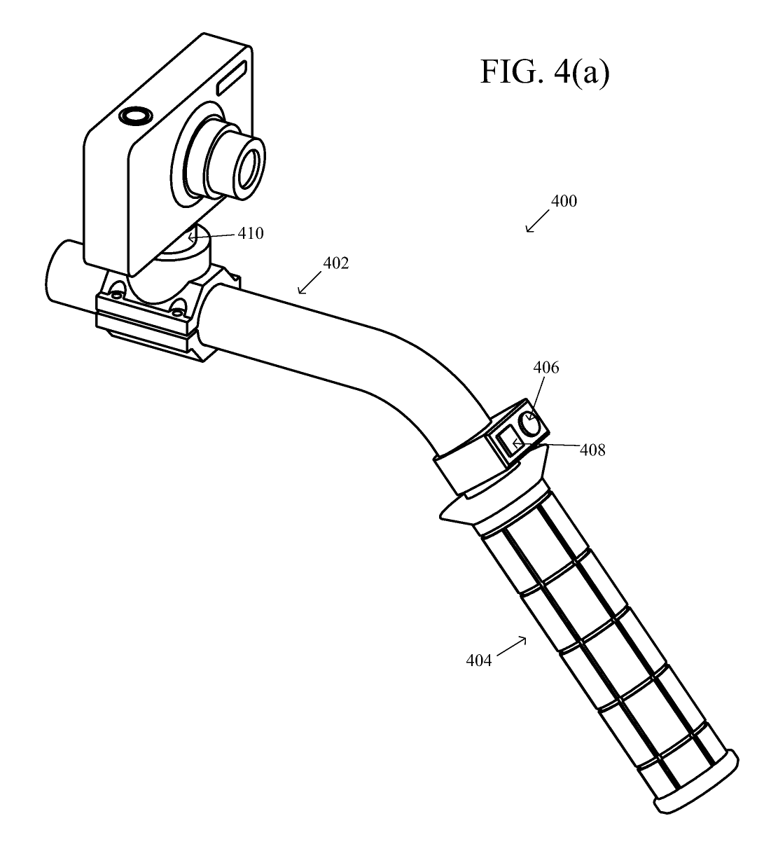

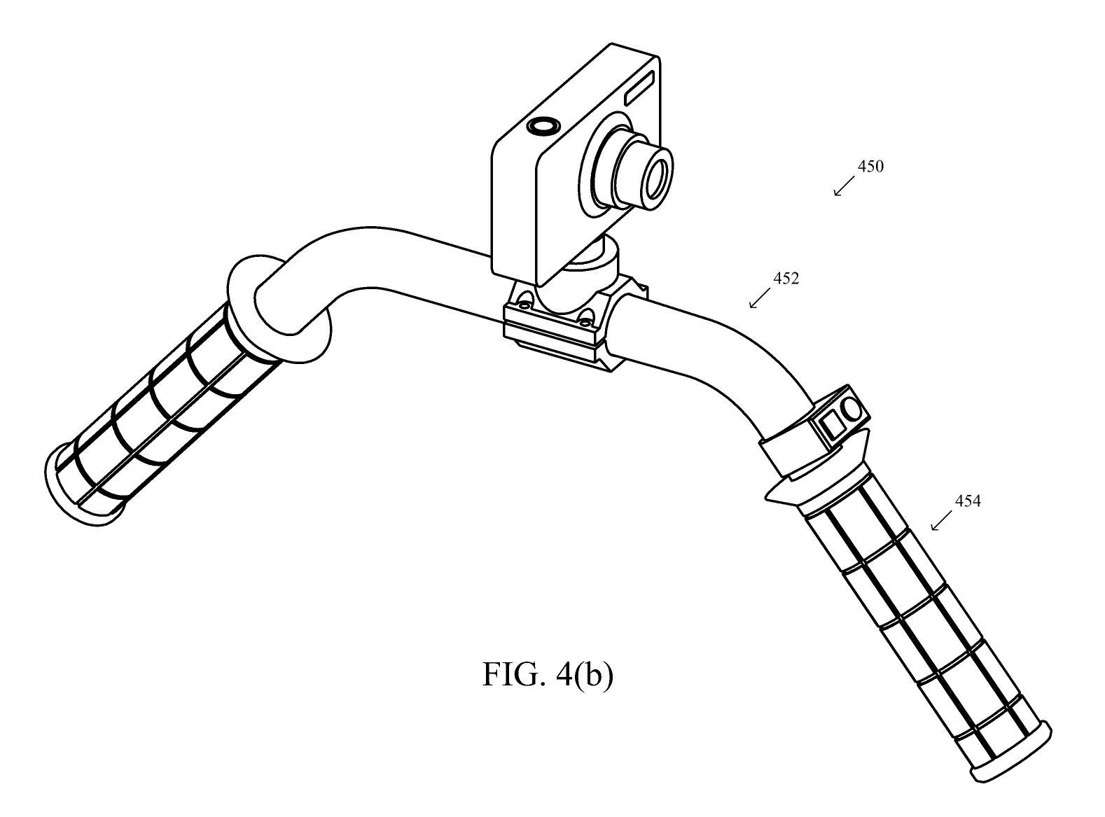

FIG. 4(a) is a simplified illustration of a perspective view of portable camera support apparatus 400 in accordance with the present invention. FIG. 4(a) shows portable camera support apparatus 400, comprising tubular member 402, grip 404, pivot control 406, camera control switch 408, and pivot coupler 410. Portable camera support apparatus 400 is designed to provide a user with increased control of what image or video is captured during the performance of an action sport or extreme activity.

Portable camera support apparatus 400 allows a user increased control of what they film during performance of an action sport or extreme activity through activation of pivot control 406 and camera control switch 408. Pivot control 406 enables the user to pivot the camera around pivot coupler 410. In such an embodiment, pivot coupler 410 may be rotated via mechanical or electrical means through activation of pivot control 406. Such rotation of pivot coupler 410 would rotate the portable camera, thereby allowing the user to capture still images or record videos of the user, other individuals, or the surrounding environment, depending upon the direction that the portable camera is facing. In an exemplary configuration, an electronic wiring or wireless connection between pivot control 406 and pivot coupler 410 would control the mechanical axis of the portable camera to rotate the portable camera to face the desired direction. Alternatively, pivot coupler 410 may be controlled through a mechanical rotating unit connected to pivot control 406 through tubular member 402.

In an exemplary usage of the present invention wherein a user of portable camera support apparatus 400 is snowboarding, the user may activate pivot control 406 with their thumb or first finger, thereby allowing the user to rotate the camera of portable camera support apparatus 400 without manually turning the camera. In such exemplary usage, the user of portable camera support apparatus 400 may turn the camera to capture images of themselves, their friends, or their surroundings, all while snowboarding.

Camera control switch 408 enables the user to turn the camera on or off, as the user sees fit. In addition, camera control switch 408 would allow the user to capture still images while performing the activity without the discomfort or danger of having to reach the portable camera. In an exemplary configuration, camera control switch 408 comprises an electrical switch to control the power, on or off, of the portable camera. In another embodiment, camera control switch 408 comprises an electrical switch that, when activated, activates the image or video capturing element of the portable camera. In such embodiments, camera control switch 408 may activate the portable camera via electrical wiring, wireless signal, or some other means of connection. Other electromechanical implementation may be used in alternative configurations to allow the user to control the power and image capturing switch of the portable camera. In exemplary usage of the present invention, a user may activate camera control switch 408 with their thumb or first finger, thereby allowing the user to activate the camera without the need to manually activate the camera during participation in an action sport.

FIG. 4(b) is a simplified illustration of a perspective view of a portable camera support apparatus 450 in accordance with the present invention. FIG. 4(b) shows portable camera support apparatus 450, comprising camera tubular member 452 and grip 454. Portable camera support apparatus 450 is designed to capture still or video images, but also to allow for turning the camera on or off, controlling the angle of the camera, and capturing still images while holding portable camera support apparatus 450 in a convenient and steady manner. Such variation would ensure safety and ease of use since the user can control different aspects of the camera while still holding camera support apparatus 450 without distraction or need to stop performing the activity to control the power or angle of the camera.

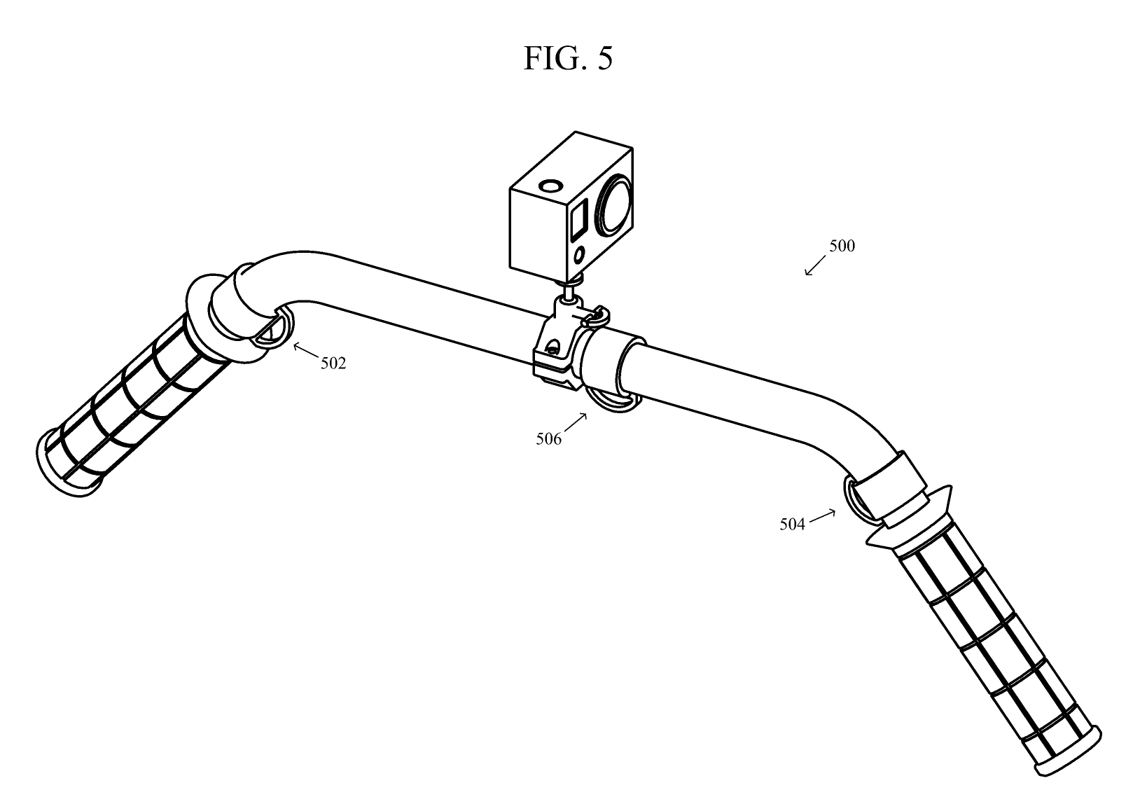

FIG. 5 is a simplified illustration of a perspective view of portable camera support apparatus 500 in accordance with the present invention. FIG. 5 shows portable camera support apparatus 500, comprising connection rings 502, 504, and 506. Portable camera support apparatus 500 is designed to be carried easily by a user, via an over-the-shoulder strap or like device, and to assist in recovery of the device during the performance of an action sport or extreme activity.

Connection rings 502 and 504 are designed to allow a user to hook a strap or like device to the distal and proximal ends of portable camera support apparatus 500. In such exemplary usage, a user may carry portable camera support apparatus 500 by the strap, over the shoulder, on the back, or in another like manner, such that the user' s hands and arms are unburdened. In an alternative embodiment, connection rings 502 and 504 may be detached from portable camera support apparatus 500, or, may be reattached to portable camera support apparatus 500 at varying points along the tubular member.

Connection ring 506 is designed to assist in the recovery of portable camera support apparatus 500 during the performance of an action sport or extreme activity. In exemplary usage of the present invention, a user may attach a strap, cable, tether, or other connector to connection ring 506. In such exemplary usage, the user may hold, tie, or attach the strap to their wrist, waist, leg or jacket, such that if the user lets go or loses control of portable camera support apparatus 500 during the performance of an action sport or extreme activity, the user will still be attached to portable camera support apparatus 500 via the strap and connection ring 506. For example, if a user were to fall while surfing and were to let go of portable camera support apparatus 500, the user would be able to easily retrieve portable camera support apparatus 500 if a strap was tied to their wrist and to connection ring 506.

An apparatus for a portable camera support apparatus has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A portable camera support apparatus for use in action sports, comprising:
a portable camera for capturing audio and visual data;
a tubular member for supporting the portable camera;
a pivot coupler for attaching the portable camera to the tubular member;
a first grip firmly secured at a distal end of the tubular member; and
a second grip firmly secured at a proximal end of the tubular member.

2. The portable camera support apparatus of claim 1, further comprising a buoyancy opening upon the tubular member.

3. The portable camera support apparatus of claim 1, wherein the tubular member comprises aluminum.

4. The portable camera support apparatus of claim 1, wherein the action sport is snowboarding.

5. The portable camera support apparatus of claim 1, further comprising a pivot activation module for rotating the portable camera upon the pivot coupler.

6. The portable camera support apparatus of claim 5, wherein the pivot activation module comprises a switch.

7. The portable camera support apparatus of claim 1, further comprising a portable camera activation module for activating the portable camera.

8. The portable camera support apparatus of claim 7, wherein the portable camera activation module:
activates the portable camera to take a visual snapshot;
activates the portable camera to begin filming;
deactivates the portable camera to stop filming;
turns on the portable camera;
turns off the portable camera;
or activates some other portable camera function.

9. A support apparatus for a portable camera used in action sports, comprising:
a tubular member with a pivot coupler for attaching to a portable camera;
a first grip firmly secured at a distal end of the tubular member; and
a second grip firmly secured at a proximal end of the tubular member.

10. The support apparatus of claim 9, further comprising a buoyancy opening upon the tubular member.

11. The support apparatus of claim 9, wherein the tubular member comprises aluminum.

12. The support apparatus of claim 9, further comprising a pivot activation module for rotating the portable camera upon the pivot coupler.

13. The support apparatus of claim 12, wherein the pivot activation module comprises a switch.

14. The support apparatus of claim 9, further comprising a portable camera activation module for activating a portable camera.

15. The support apparatus of claim 14, wherein the portable camera activation module:
activates the portable camera to take a visual snapshot;
activates the portable camera to begin filming;
deactivates the portable camera to stop filming;
turns on the portable camera;
turns off the portable camera;
or activates some other portable camera function.

16. A portable camera support apparatus for use in action sports, comprising:
a portable camera for capturing audio and visual data;
a tubular member for supporting the portable camera;
a pivot coupler for attaching the portable camera to the tubular member; and
a grip firmly secured at a distal end of the tubular member.

17. The portable camera support apparatus of claim 16, further comprising a buoyancy opening upon the tubular member.

18. The portable camera support apparatus of claim 16, further comprising a pivot activation module for rotating the portable camera upon the pivot coupler.

19. The portable camera support apparatus of claim 18, wherein the pivot activation module comprises a switch.

20. The portable camera support apparatus of claim 16, further comprising a portable camera activation module for activating a portable camera.
